(19) United States
(12) Patent Application Publication
(10) Pub. No.: US 2014/0209572 A1
(43) Pub. Date: Jul. 31, 2014

(54) CONTACT DEVICE FOR CONTOURED SURFACES

(71) Applicant: ROLLS-ROYCE PLC, London (GB)

(72) Inventors: Christopher James WILLIAMS, Newport Pagnall (GB); Martyn Anthony JONES, Chesterfield (GB); Andrew James GILMOUR, Derby (GB); Andrew James LODGE, Bishop Auckland (GB); Kwok Hei WONG, Abingdon (GB); Jonathan Robert HAM, Sheffield (GB)

(73) Assignee: ROLLS-ROYCE PLC, London (GB)

(21) Appl. No.: 14/150,215

(22) Filed: Jan. 8, 2014

(30) Foreign Application Priority Data
Jan. 25, 2013 (GB) 1301310.7

(51) Int. Cl. B23K 9/32; B23K 9/16

(52) U.S. Cl. CPC B23K 9/325; B23K 9/164
USPC 219/74

(57) ABSTRACT

There is provided a contact device (10) for application to an opposing surface (46;50) in use. The contact device comprises a support (12) and a plurality of contact members (14) aligned along the support. Each contact member has an end portion (15) spaced from the support and is independently resiliently mounted to the support such that the end portions (15) can conform to the opposing surface (46;50) in use and thereby provide a seal there-against. The contact members and/or support and may be planar in form and may be cut from a sheet metal material. The contact device may serve as a gas shield or a support jig or clamp device.

### BACKGROUND OF THE INVENTION

The present invention relates to a contact device and more specifically, although not exclusively, to a contact device which is capable of forming a gas shield or seal against a contoured surface.

For a number of engineering operations it is desirable to define a controlled atmosphere about an application point or zone. Operations of this kind include, for example, manufacturing or material processing applications, such as welding, machining or the like. For such operations it is often desirable to shield thermally excited regions with a gas other than air in order to avoid degradation of materials by reaction with oxygen or nitrogen. This is particularly the case for reactive metals, such as titanium.

Inert gases may be fed under pressure to the desired zone to establish the controlled environment.

For some types of products, it is possible to maintain the entire product within a controlled environment for the duration of the process. However for other products or components it is desirable to provide a localised gas sealing/shielding system, typically referred to as a ‘gas box’, about the specific region in which processing is taking place. A conventional gas sealing system is adapted to be fitted over the area to be purged with gas when subjected to elevated temperatures.

This presents a problem for products having contoured surfaces since the gas seal system must be adapted to fit against the specific contour at the desired location in order to provide an effective seal. That is to say, a conventional gas seal system must be tailored to the contour of the surface in question. Contoured components of this type include bodies intended to provide aerodynamic, hydrodynamic or other fluid-washed surfaces in use. Examples of such bodies may comprise aerofoils, such as blades or vanes, as used in fluid flow machines, such as gas turbine engines, pumps or other flow-diverting or lift-inducing equipment.

One significant disadvantage with the gas seal arrangements described above is that a gas seal is bespoke to the contour of the component and so a new seal must be produced to match any changes in geometry for the component in question. Whilst it has been contemplated by the inventors to use a conventional deformable seal to allow for variation in surface geometry between different products or different iterations of the same product, such sealing materials are typically not capable of withstanding elevated temperatures that may be experienced during processing operations such as welding or the like. By way of example, for welding applications it may be necessary for the seal to withstand a temperature of 500° C. or greater for prolonged periods of time.

It is an aim of the present invention to provide a contact device which can better accommodate variations in geometry, for example of a contoured surface against which the contact device is located in use.

### BRIEF SUMMARY OF THE INVENTION

According to a first aspect of the invention there is provided a contact device comprising a support and a plurality of contact members aligned along the support, each contact member having an end portion spaced from the support and being independently resiliently mounted to the support such that the end portions can conform to an opposing surface in use and thereby provide a seal there-against.

The contact members may be aligned so as to provide an elongate seal along the opposing surface. The contact members may be aligned along a length of the support. The support may be a common support. The contact members may depend from the support.

The independent resilient mounting of the contact members may advantageously allow a substantially continuous seal to be formed along the plurality of contact members against a curved, or otherwise contoured, opposing body.

The contact members may be arranged in a linear array or row. The contact members may be arranged side-by-side. The contact members may each have a lateral edge portion which is in contact with a lateral edge portion of the adjacent contact member.

The contact members may have a depth or wall thickness dimension which is substantially smaller than a width or length/height dimension thereof. The depth of the contact member may be at least an order of magnitude smaller than the width or length/height. The contact members may be aligned within a common plane.

The support may have a depth or wall thickness dimension which is substantially smaller than a width or length/height dimension thereof. The depth of the support may be at least an order of magnitude smaller than the width or length/height. The width dimension may be longer than the height dimension such that the support may be elongate in form.

The contact members and/or support may be substantially planar in form. The contact members and support may be arranged in a coplanar arrangement. The contact members may define a plurality of teeth-like members depending from the support.

The contact members and/or support may be formed from a planar or sheet material. The contact members and/or support may be cut from a sheet material, for example by laser cutting.

Each contact member may have a resilient mounting. The resilient mounting may depend from the end portion towards the support. The resilient mountings may be spaced along the support.

The resilient mountings may be arranged to bias the contact members in a direction contained within the plane of the contact members.

The resilient mountings may comprise springs. The resilient mountings may comprise cantilever or radial springs. The springs may be planar in form. The resilient mountings may be coplanar with the contact member end portion and/or support.

In some embodiments each contact member may be integrally formed with a resilient mounting. The contact member and resilient mounting may be formed (e.g. cut) from a common sheet material. The resilient mounting may be cut from a sheet material.

Each contact member, or its resilient mounting, may be removably mounted to the support.

Each contact member, or its resilient mounting, may comprise a first mounting formation for mounting to a corresponding mounting formation in the support member. The first mounting formation may comprise a lug or head formation. The corresponding mounting formation may comprise a recess arranged to receive said head or lug. The lug and/or recess may be arcuate, e.g. elliptical or generally circular, in plan.

The contact member may comprise side wall portions extending from the end portion. The side wall portions may extend rearwardly from the end portion towards the support. The resilient mounting may be located between said side wall portions. The contact member, i.e. the end portion and side walls, may be substantially U-shaped.

The end portion of each contact member may comprise an end wall or edge. The end portion may be curved in profile.

The support may have a plurality of projections (e.g. intermediate projections) arranged between adjacent contact members. The projections may be shorter in height than the contact members. The projections may extend only part way along the height of the contact members. The projections may be linear/straight in form. The projections may advantageously serve as alignment members for the contact members, for example to ensure that freedom of movement of the contact members is limited to one dimension. The projections may define slot formations for receiving the contact members.

The contact members may be arranged to move in a direction that is substantially perpendicular to the support (e.g. perpendicular to a length direction of the support). The contact members may all move in parallel directions. The contact members may move back and forth in a direction towards and away from the support.

The contact members may be mounted for movement in a direction that is substantially perpendicular to the opposing surface in use. One or more contact member may move in a direction that is angularly offset from an adjacent contact member.

The height of the resilient mountings, in an undeformed condition, may be substantially equal.

The support may be curved in profile. The support may have a curved edge, along which the contact members may be resiliently mounted.

The support and contact members may be retained between two opposing walls in use. The support and contact members may be sandwiched there-between. The end portion of the contact members may protrude beyond the opposing walls.

In use, all of the contact members may be maintained in a resiliently biased condition against the opposing surface.

The support and contact members may define a wall-like assembly. The contact device may take the form of a wall, such as a sealing wall, or gas shield. The contact device may provide a seal along its minor edge or surface. The contact device may provide a local gas shield for use in machining, welding or other material processing or engineering operations. The contact device may comprise an enclosure or partial enclosure.

The contact device may comprise a plurality of rows of contact members, wherein each contact member in a row is substantially aligned with the other contact members in the same row. The contact members in one row may be offset e.g. longitudinally or laterally offset) from the contact members in an adjacent row.

The contact device may comprise at least three contact members and typically five or more contact members. Any or any combination of the contact members, resilient mountings and/or support may be formed of a metal.

According to a second aspect of the invention, there is provided an enclosure comprising a plurality of contact devices according to the first aspect, or any embodiment thereof. The contact devices may provide a plurality of walls of the enclosure. Each device may comprise at least one row of contact members. The enclosure may be a partial or complete enclosure.

The walls of enclosure may be arranged to provide a seal against the opposing surface so as to enclose a volume of fluid against the surface.

The enclosure may comprise a gas inlet for receiving one or more gases under pressure in use. A gas inlet port may be provided for connection to a source of pressurised gas. The gas may be an inert gas, such as argon. The enclosure may be capable of maintaining an elevated gas pressure against the opposing surface in use.

The enclosure may comprise an opening and/or mounting formation for a tool, such as a machining, welding or other material processing tool.

The plurality of contact devices (e.g. the supports and/or rows thereof) may be arranged perpendicularly. The enclosure may be substantially quadrilateral in plan.

According to a third aspect of the invention, there is provided a support jig or clamp assembly comprising one or more contact device according to the first aspect, or any embodiment thereof.

At least a component of the weight of a larger body may be supported on the end portions of the contact members.

A plurality of contact devices may be held at spaced locations for supporting the weight of a larger body at least in part between said contact devices. The contact devices may be aligned with parallel but spaced axes.

One or more pairs of contact devices may be provided, wherein a first contact device of said pair may oppose a second device. A body may be held between said opposing first and second devices. The first and second contact devices may be arranged for relative movement so as to allow opening and closing of the contact devices about the body. Such an arrangement may be used as a clamp, for example to deform and thereby shape a body of material located between. A clamping force may be applied to the support of the first and/or second device in the direction of the other device.

Wherever practicable, any of the essential or preferable features defined in relation to any one aspect of the invention may be applied to any further aspect. Accordingly the invention may comprise various alternative configurations of the features defined above.

### BRIEF DESCRIPTION OF THE DRAWINGS

Practicable embodiments of the invention are described in further detail below by way of example only with reference to the accompanying drawings, of which:

FIG. 1 shows a side view of a contact device according to one example of the invention;

FIG. 2 shows a side view of a contact device according to another example of the invention;

FIG. 3 shows a plan view of a contact member of the device of FIG. 1;

FIG. 4 shows a section view through a device according to one embodiment of the invention when mounted for use;

FIGS. 5a and 5b show respective three-dimensional views of a contact member and contact device according to a further example of the invention;

FIGS. 6a and 6b show respective three-dimensional views of a contact member and contact device according to another example of the invention;

FIG. 7 shows a side view and a plan view from below of a contact device assembled for use;

FIG. 8 shows a three-dimensional view of the arrangement of FIG. 7;

FIG. 9 shows a three-dimensional view of the arrangement of FIG. 7 in use against a contoured body;

FIG. 10 shows a three-dimensional view of a further application of a contact device in accordance with an example of the invention;

FIG. 11 shows a side view of the contact device of FIG. 8; and,

FIGS. 12a to 12c show side views of a contact device according to a further example of the invention being used in a clamping/shaping process.

### DETAILED DESCRIPTION OF THE INVENTION

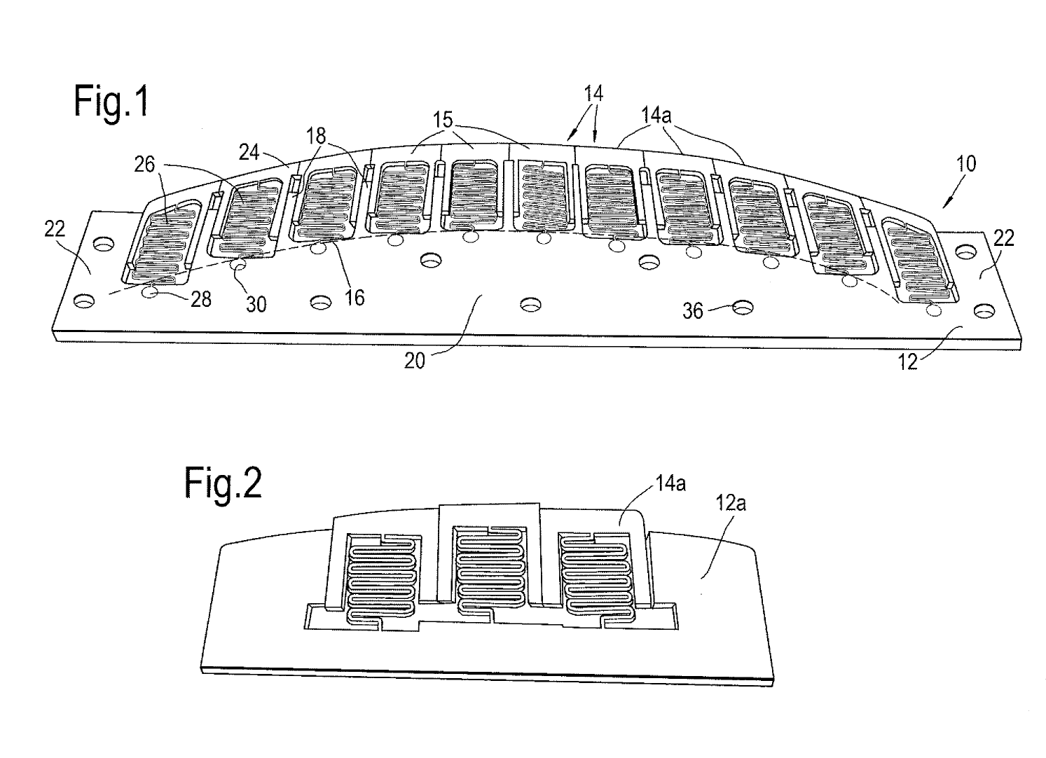

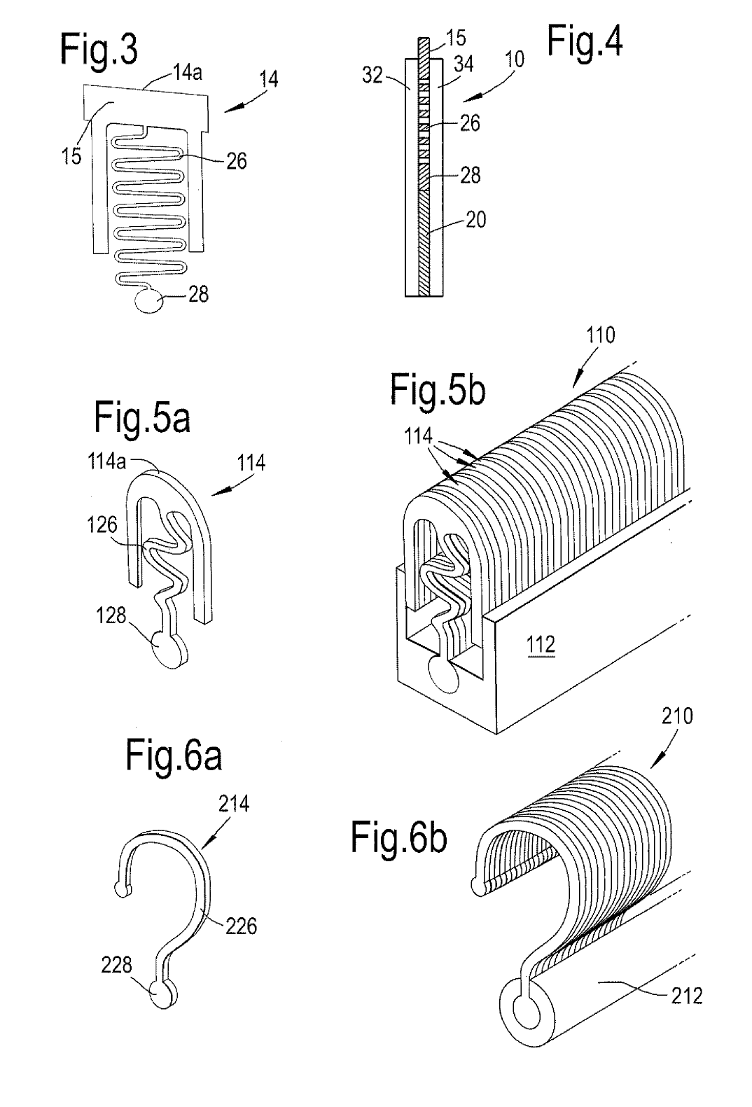

Turning to FIG. 1, there is shown an example of a contact device 10 according to an example of the invention. In FIG. 1 a cover member has been removed to show the internal arrangement of the device. The device generally comprises a support member 12, to which are mounted a plurality of contact members 14. In the embodiments described below, the device comprises a planar structure, akin to a wall or shield.

The support 12 is itself substantially planar (or thin-walled) in form and has a mounting edge, indicated by dashed line 16, from which the contact members 14 depend. The support comprises a base section 20 and flanking wall sections 22 at opposing sides/ends thereof. The base terminates at the mounting edge 16. That mounting edge 16 is in this embodiment, formed of a plurality of mounting edge formations, separated by intermediate projections or fingers 18. The projections 18 are spaced along edge 16 and depend outwardly from said edge. The projections define a plurality of spaced slots along edge 16, in which the contact members 14 can be received.

The mounting edge 16 follows a curved or arcuate path in this embodiment which may approximate the contour of a surface against which the contact member is intended to be held in use as will be described below. In other embodiments the mounting edge could be substantially flat.

The contact members 14 are themselves planar (or thin-walled) in form and are arranged in a side-by-side configuration so as to define a linear array. The array of contact members are aligned such that they are maintained in a common plane. The contact members 14 each have a head or end portion 15 which terminates at an outer or leading edge 14a, which is spaced furthest from the base portion 20 of support 12. An individual contact member 14 is shown in FIG. 3.

A leading edge 24 of the device 10 is formed of the individual leading edges of the contact members 14. Adjacent contact members 14 are in close contact or else have minimal gap therebetween such that the leading edge 24 of the device is substantially continuous. In this embodiment, the individual leading edges 14a of the contact members are each curved along their length so as to define a leading edge 24 which is arcuate or curved in form.

The contact members 14 are mounted to the support 12 by spring mounting formations 26. The spring formations 26 comprise cantilever springs defining a tortuous path between the mounting edge 16 and the end portion 15 of the contact members. In this embodiment the spring formation 26 depends from a rear or inner edge of the end portion 15, which faces the support 12. The cantilever spring 26 preferably passes back and forth at least four or five times between the end portion 15 and support 12. The cantilever spring preferably passes back and forth at least eight or ten times, and specifically fourteen times in this example. This has been found to provide a suitable range of deflection of the contact members, whilst maintaining a desired level of rigidity or resilience.

The spring mounting formation 26 terminates at a mounting lug 28. The support comprises a plurality of recesses or cut-outs 30 adjacent the edge 16 thereof. The recesses 30 are correspondingly shaped to receive a mounting lug 28. In this embodiment, the lugs 28 and recesses 30 are circular in plan.

Whilst the contact members 14 are individually formed in the embodiments of FIGS. 1 and 3 and mounted to the support 12, a different example of the invention is shown in FIG. 2, in which the support 12a and contact members 14 are co-formed out of a common piece of sheet material. In this example the mounting edge 16a is flat or stepped to accommodate the desired height of the contact members 14a, although the edge 16a could also be curved as shown in FIG. 1. Any of the features described above in relation to FIG. 1 may also be applied to the example of FIG. 2, save for the mounting lug and recess formations.

When the contact device is assembled for use, the support 12 and contact members 14 are arranged as shown in FIG. 1 or 2 in a generally planar construction. That construction is held between two opposing mounting/cover members 32 and 34, which may also be planar or plate-like in form (i.e. backing plates) which trap the contact members 14 and serve to maintain the desired planar alignment thereof in use. Bolts or other fasteners (not shown) may pass through apertures 36 in the support 12 and plates 23/34 in order to hold the assembly together.

The device 10 provides a conformable (i.e. variable geometry) fluid seal that can operate reliably in high-temperature environments, for example which may exceed 500° C. The individually sized and profiled teeth are aligned to make up a sealing edge which can be pressed against a contoured surface in use to define a seal there-against. Furthermore the device can be made utilising rapid manufacturing technology, e.g. by cutting the support and contact members out of simple sheet material. The spring teeth may be laser cut individually rather than as a single assembly and then simply attached to the support by the mounting formations described above. This ensures that teeth could be individually removed and replaced if necessary and that the sealing surface can be manufactured with zero gaps between teeth. The individual teeth also allow internal stresses/strains to be resolved between teeth so as to minimise any unwanted global deformation or movement or residual stress in the device, e.g. due to the method of cutting the device during manufacture or else upon heating in use, etc.

The spring-mounting enable deflections between adjacent contact members (i.e. in the same plane in a direction towards or away from the opposing surface), allowing the seal to conform to various curved surface geometries. Thus the device can be reused to seal effectively against a variety of different surface geometries, such as different aerofoil shapes.

The manufacture of the device from sheet material is highly accurate yet relatively cheap, simple and safe. The integral formation of the springs with the contact members (e.g. by laser cutting from a common sheet) further simplifies the manufacturing process. Contact members can also be easily replaced through disassembly of outer covers. A further potential advantage of the proposed invention is that it can be custom made for a specific application, owing to the flexible nature of the cutting process. It can also be easily integrated into any system, as attachment features can be built into the spring unit itself.

In any example of the invention, the contact members and/or support may be formed from a metal material, such as a Titanium alloy. The cover plates are formed of steel, which could also be used for the support/contact members in other embodiments.

In various different embodiments of the invention, it is envisaged that varying numbers of contact members may be provided, for example between three and thirty or more contact members may be used depending on the profile of the surface to be contacted. It is generally perceived that between six and twenty contact members would generally be sufficient to accommodate varying aerofoil profiles and around ten to twelve contact members has been found to represent a good balance between manufacturing cost and seal quality.

The wall thickness of the contact members 14 and/or support 12 may be between for example 0.5 or 0.7 mm and 5 mm, and preferably between 1 and 3 mm. A wall thickness of between 1.5 and 2 mm, e.g. approximately 1.6 mm, was used in the example shown. The separate manufacture/cutting of the contact members and support was found beneficial as it allowed the support to be of slightly greater wall thickness than the contact members, for example by 0.1-0.2 mm or more. This allows reduced friction upon movement of the contact members between the cover plates.

The individual contact members may have a width of between 5 and 50 mm, typically between 10 and 30 mm, and in the example of FIG. 1 a width of approximately 20 mm was used. Accordingly the total length of the device in FIG. 1 is approximately 260 mm, although it is to be noted that the device may be scaled up or down to suit the surface to be contacted or the different uses of the device to be described below. It is felt that the device may total width/length in size from, for example from 50 or 100 mm up to 500 mm or even up to 1 m. Accordingly the height of the device could range from approximately 20 mm to 100 mm or more as necessary.

The examples of the invention shown in FIGS. 1-3 were designed to provide a range of contact member deflection in the order of a few millimetres, such as between 2-20 mm and preferably in the order of 5-10 mm to accommodate the possible variations in aerofoil geometry. Those examples were designed to accommodate different known profiles of outlet guide vane geometries for gas turbine engines, although it will be appreciated that a variety of other uses and applications may be forthcoming.

The intermediate projections 18 described above, were found to be useful in limiting the maximum range of deflection of the contact members 14. Thus those projections serve in use as stop members. The permitted range of deflection (i,e. the height of the projections) can be tailored to prevent compression of the spring beyond its yield limit.

The spring profiles, e.g. spring length, wall thickness, number of cantilevers and/or cantilever taper angle, were all set in line with basic spring stiffness calculations. The parameters achieved the desired spring stiffness within desirable height limitations. The springs in FIG. 1 all have the same profile but profiles may vary in other examples as necessary. Each spring may be tailored to its corresponding slot in the assembly, for example by having the first bend directed to the side of the slot with the largest amount of material or height. This was found to be important for contact members that have a steep angled sealing profile. It also increased the length of spring that could be accommodated for a given total height of the device.

All the contact members have been aligned to extend and retract in a common direction. It is also an option to allow flexion of the contact members in a direction radial to the surface to be contacted. However aligned (e.g. vertical) contact member movement has been found beneficial for a number of applications to direct the loading on the opposing surface as required and also to minimise gaps (i.e. leakage) between adjacent contact members.

In addition, it has been found through various iterations of design that the difference in compression distance required for certain surface geometries may give rise to the issue that some springs can be consistently fully compressed against a particular portion of the geometry, with other springs being not compressed or minimally compressed against a different portion. To achieve an appropriate seal, it has been found to be desirable that there is some compression (i.e. a minimum compression threshold) of all springs in all instances of use of the device. A minimum compression of one or two millimetres has been found adequate in the examples shown and the shape of the edge 16 is designed to cause such minimum compression of all springs in use for the desired range (e.g. tolerance) of aerofoil surface to be accommodated.

Turning now to FIGS. 5 and 6, there are shown two further examples of devices according to the principles of the invention. In those examples, the contact members 114 and 214 are arranged to be aligned in a side-by-side or back-to-back arrangement rather than the end-to-end arrangement described above in relation to FIGS. 1-3. That is to say, the individual contact members 114, 214 are arranged in a substantially linear array extending in a first direction. Each contact member is arranged substantially laterally or perpendicularly to the first direction, i.e. such that it is perpendicular to the direction of the seal. The contact members may be otherwise as described above.

The orientation of the contact members in FIGS. 5 and 6 allows the contact device to adhere with greater accuracy to suit surface geometries that display a greater degree or rate of surface variation. In FIG. 5, the contact member 114 may be as described in relation to FIG. 3 save that the leading edge 114 may be curved to a greater degree. The series of contact members 114 are held within a support member 112 which takes the form of a trough or channel. The support member in this embodiment is generally U-shaped in section and may have one or more retaining formations along its length. The retaining formation may be in the form of an elongate slot or groove in the base of the support member.

In FIG. 6, in place of the cantilever spring arrangement—which allows substantially linear deflection of the contact members in use—each contact member 214 is provided with a radial-type spring portion 226. A simple radial spring form is provided in this example such that the deformable portion of the contact member comprises a substantially continuous curve or continuously-handed curve formed between the leading edge 214 and the mounting portion 228. The support member may thus be provided as described above in relation to FIG. 5 or else may comprise a simple rail formation 212 as shown in FIG. 6b.

Whilst the embodiments described above show only a single row, i.e. a one-dimensional array, of contact member, it is to be noted that in other embodiments it may be desirable to provide two or more rows. Accordingly a plurality of linear arrays may be provided, for example to increase the quality of the seal. The rows of contact members may be provided in an immediately adjacent arrangement, whereby one row contacts the adjacent row or is separated by a minimal gap. Alternatively, the adjacent rows may be spaced by a mounting plate, such as plate 32 or 34 as described above.

In one example adjacent rows of contact members are offset or otherwise arranged ‘out of phase’ such the ends of the individual contact members in one row do not coincide with the ends of the contact members in an adjacent row. To this end, the width dimension of the contact members in one row may differ to those of an adjacent row. Alternatively a common width of contact member may be provided but the contact members may be mounted in an offset configuration. The retaining formations in the support member may be arranged accordingly.

Such an offset design means that any gaps in the seal between adjacent contact members of one row are sealed by the adjacent row. This would lead to decreased fluid leakage across the seal. Potentially, there could be any number of rows that can be tailored to the particular application.

Two rows of contact members may be accommodated by a single support member having suitable retaining formation for both rows or alternatively a single support member may be provided for each row of contact members.

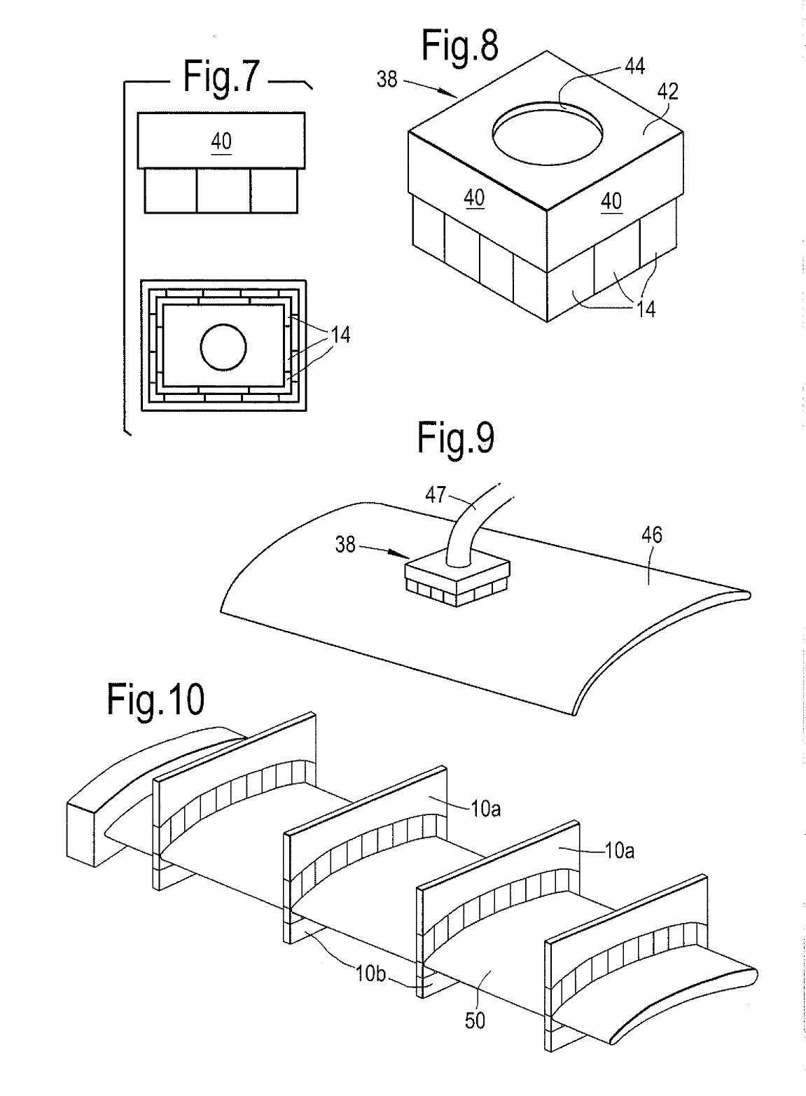

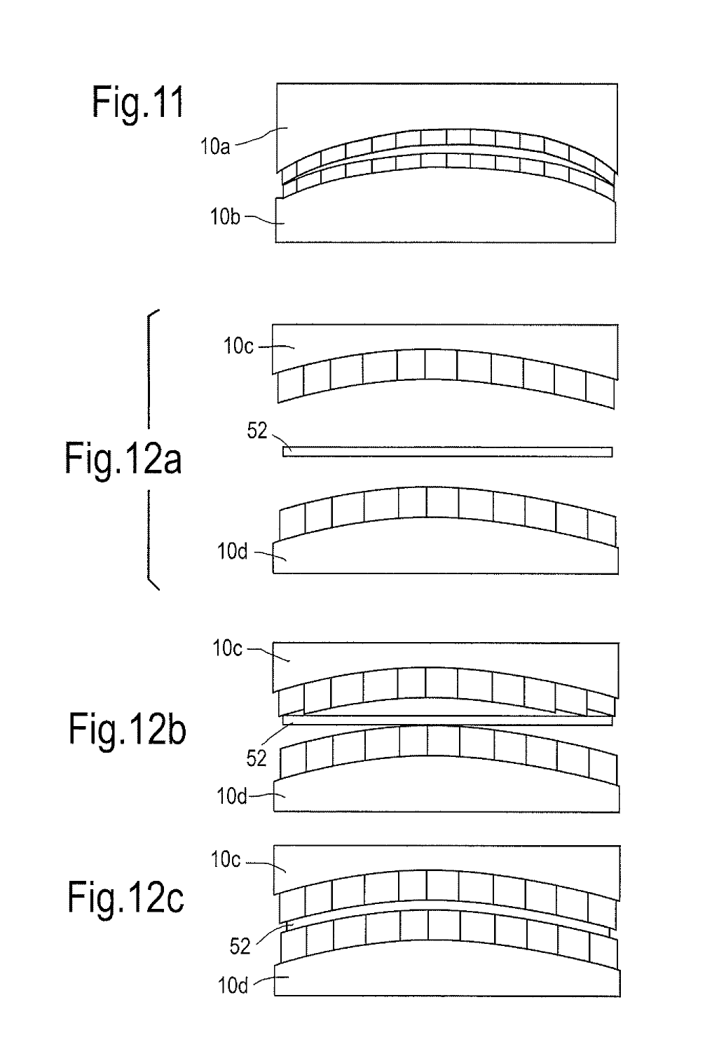

Turning now to FIGS. 7 to 9, there is shown one application of the contact device according to the invention. A plurality of contact devices 10 (or 110 or 210) of the type described above are provided so as to form an enclosure 38. Each device 10 provides a wall 40 of the enclosure 38. Each device is preferably adjoined to an adjacent device at each end thereof. Each device is arranged substantially perpendicularly to an adjacent device so as to form an enclosure that is substantially rectangular, or square, in plan. As shown in FIG. 7 each wall preferably comprises a plurality of rows of contact members 14 as described above but a single row may be provided in alternative embodiments.

The enclosure has an upper wall or ceiling 42 which is attached to the support member and/or mounting plates at a distal edge thereof. Thus the enclosure comprises a five-sided or walled construction. The upper wall 42 has an opening 44 therein which is arranged to receive a gas conduit 47 as shown in FIG. 9.

The enclosure 38 thus provides a gas box arrangement, suitable for welding or other applications in which it is desirous to create a localised enclosure over a region of a surface 46 to be processed.

This enclosure 38 can then be pushed onto a curved surface 46 and provides a seal about a desired Location on the surface. The individual contact members 14 can thus deform as described above in order to maintain good contact with the surface 46 about the perimeter of the enclosure. A gas, such as an inert gas, may be fed to the interior of the enclosure 38 via conduit 47 in order to provide the desired localised atmosphere. The gas may be delivered at atmospheric temperature or else at a desired temperature to suit the application at hand.

The sealed enclosure 38 would have a very high temperature resistance, and so could be used, for example, for rapid localised resin curing. By pumping hot air or other gas into the unit, a high temperature could be maintained to allow applied resin to cure quickly. This, in addition to welding applications, may be particularly useful for repairs, e.g. an emergency repair to a metal or composite component such as an aerofoil. A membrane could also be applied between the unit and a composite, which would allow the supplied gas to apply pressure to the repair area. Similarly, an inert gas could be pumped into the unit to facilitate basic spot weld repairs to metal structures. This would typically require one or more further openings in the enclosure to allow access for welding apparatus.

In another example of use of the invention, a plurality of devices 10 (or 110 or 210) may be used within a support system or a jig 48 as shown in FIG. 10. Geometric variability, particularly in large components can provide difficulty in holding of a body 50 in a fixed datum position during inspection or other contact operations. By using one or more contact devices 10 to hold the body 50, a greater accuracy or ‘best fit’ orientation of the body can be achieved. In one embodiment a single contact device 10 can be used to support a portion of the weight of the body at a distance from a fixed location.

In the embodiment of FIG. 10 however a plurality of devices 10 are provided at spaced locations along/across the body 50. At each support location, an opposing pair of contact devices 10a, 10b may be provided to hold the body therebetween. The opposing contact devices 10a, 10b may be aligned in substantially the same plane or else may be offset. Thus the resilient movement of the contact members of the opposing devices 10 occurs in opposite directions so as to grip the body therebetween. This opposing resilience or biasing force centres on a desired location of the body 50 and achieves a ‘best fit’ position of the body. One advantage of using biased contact members in this application is that inspection rigs or other holding jigs could be easily modified to take different components, either using a common set of contact devices or simply by replacing the contact members as necessary.

A plurality of opposing pairs of devices 10a, 10b may be provided along the length of an elongate component such as a fan blade or other aerofoil, hydrofoil or similar. A side view of the opposing contact members 10a and 10b in use is shown. Thus the leading edges of the contact members of the opposing devices may define a desired aerofoil section in an at-rest or else desired deformed condition.

Additionally or alternatively, the sprung profile between two opposing contact devices 10a and 10b could also be used as a clamp, for example in assembly processes, in order to ensure that the required clamping force is applied, yet whilst avoiding excess force being used which could damage the component being held.

In a further example of use of the invention, opposing contact devices may be provided in the form of deformation device which is capable of shaping a length or sheet of relatively thin-walled material. For example a press apparatus may make use of opposing devices according to one example of the invention.

The opposing devices 10c and 10d may serve as a liner press as shown in FIGS. 12a to 12c. By using opposing sets of tooth springs, a material 52, such as a sheet material, could be ‘nipped’ into defined complex profiles. In such an embodiment the opposing devices 10c and 10d are each arranged such that the leading edges of the contact members define a desired surface profile for the sheet material once formed. Thus the leading edge of one device 10c will typically be the corresponding inverse of the opposing device 10d. That is to say the curvature of the opposing leading edges may be equal but opposite.

In use the material body 52 is placed between the opposing devices 10c and 10d. The devices are then brought together such that the body 52 is clamped therebetween as shown in FIG. 12b. The clamping force exerted on the material (i.e. the force applied to bring the opposing devices together) is increased such that it deforms the body 52 to the desired profile as shown in FIG. 12c.

This use of the invention is beneficial in that the resilience of the contact member springs can be set to match the desired clamping force for bending/shaping of the body 52. Accordingly the desired deformation force can be applied but with a degree of resilience to allow the body to deform adequately. As shown in FIG. 10, if a plurality of opposing clamp devices is provided in spaced relationship, a desired complex net shape can be achieved as a best fit between the profiles of the adjacent sets of clamps. Such a shaping tool can reduce the induction of localised stresses in the material 52, since forming stresses are better distributed across the operation, as opposed to being localised in specific areas at particular times.

In such an embodiment, the springs 26 would need to be tailored so that the force applied to the material is appropriately proportional to their deflection. That is to say the stiffness of each spring will typically be greater than the relative stiffness of the material. Each spring could be designed differently so that the contact members deform differently under loading in order to further control the deformation process. In one example the shaping tool of the invention may be used during thermoplastic or metal forming operations.

In the above differing uses of the invention, it has been found to be a beneficial attribute of the contact devices that the initial spring deflection upon contact with a contact member may occur at a relatively low applied force but the resilience to deflection rises with deflection distance thereby biasing the contact members towards an initial, at-rest configuration.

Whilst the above-described contact members are aligned linearly, alternatively a radial alignment could be more suitable for more curved or cylindrical components. Additionally the shape and elasticity of the contact member spring could be modified to apply an uneven load to the sealing surface along the length of the seal, which could assist for certain geometries. In a similar fashion, each contact member could provide its seal by rotation as opposed to linear displacement, as radial springs can also be easily manufactured using the same method. Several types of springs (cantilever, helical etc.) could be used to the same effect, including potential using off the shelf springs installed as a separate component in the seal assembly. Thus independent springs or integral spring formations may be accommodated in differing implementations of the invention.

In any embodiment, the contact region 15 of each of the contact members could have a flexible material portion, i.e. at the leading edge 14a, to improve the seal formed thereby. An extra gap thereby created between adjacent contact members could be mitigated by an additional row or rows of teeth.

As a further development of the invention, strain gauges on each spring formation could be used. Such strain gauges may be used, depending on the particular implementation of the invention, either to measure the profile of the surface to which the contact member is applied or else to accurately measure an applied force via the contact device. This has good potential for rapidly measuring the conformance of products without expensive equipment.

Furthermore the invention could be used for profiling and assessing damaged surfaces, such as aerofoils. By incorporating a locking mechanism for the springs, once they have been pushed against the aerofoil, the geometry can quickly and cheaply be recorded. Strain gauges on the springs could further add to measurement capabilities.

There may also be possible application of such a temperature gas seal as a functional part in the gas stream of a fluid flow machine such as a gas turbine engine or other type of engine or pumping equipment. Potentially the spring design can be adapted to any scenario where a liner fluid seal is required, and the geometry of the surface to be sealed either changes or has a high degree of variance. The technology lends itself well to repair scenarios where requirements are unpredictable, and access to equipment is more limited. The seal could be used as a direct replacement for leaf spring seals and brush seals on a rotating shaft, such as a concentric shaft arrangement.

1. A contact device for application to an opposing surface in use, the contact device comprising:
a support and a plurality of contact members aligned along the support, each contact member having an end portion spaced from the support and being independently resiliently mounted to the support such that the end portions can conform to the opposing surface in use and thereby provide a seal there-against.

2. A contact device according to claim 1, wherein the support is elongate in form and common to the plurality of contact members, the contact members being aligned in a row along a length of the support so as to provide an elongate seal along the opposing surface.

3. A contact device according to claim 1, wherein the contact members have a wall thickness dimension which is substantially smaller than a width and height dimension thereof, the contact members being aligned in a side-by-side orientation in a common plane.

4. A contact device according to claim 3, wherein the support has a wall thickness dimension which is substantially smaller than a length and height dimension thereof, the support being substantially coplanar with the contact members.

5. A contact device according to claim 1, wherein the contact members define a plurality of metal teeth depending from the support, which may also comprise a metal.

6. A contact device according to claim 1, wherein the contact members and/or support are formed from a planar or sheet material, thereby define a sealing wall which serves as a gas shield when placed against the opposing surface.

7. A contact device according to claim 6, wherein the contact members each have a resilient mounting interposed between the end portion and the support.

8. A contact device according to claim 7, wherein the resilient mountings are arranged to bias the contact members in a direction contained within a plane of the contact members and/or support.

9. A contact device according to claim 7, wherein the resilient mountings comprise springs, which are planar in form.

10. A contact device according to claim 7, wherein each contact member is integral with its respective resilient mounting.

11. A contact device according to claim 7, wherein each resilient mounting comprises a mounting head formation for mounting to a corresponding recess formation in the support member, said recesses being spaced along the support member.

12. A contact device according to claim 1, wherein the contact member comprise side wall portions extending rearwardly from the end portion towards the support and a resilient mounting is located between said side wall portions.

13. A contact device according to claim 1, wherein the end portion of each contact member is curved in profile.

14. A contact device according to claim 6, wherein the support has a plurality of projections arranged between adjacent contact members, the projections serving as alignment members for the contact members and/or stop formations to limit the freedom of movement of the contact members.

15. A contact device according to claim 1, wherein all of the contact members are biased by said resilient mounting towards an at-rest position spaced from the support and said contact members are arranged to move in substantially parallel directions against the resilience of the mounting in a direction towards the support when pressed against the opposing surface in use.

16. A contact device according to claim 1, comprising a plurality of rows of contact members.

17. A contact device according to claim 1, comprising a plurality of supports, each support being angularly offset from an adjacent support and each support having a plurality of contact members depending therefrom such that the contact device defines an enclosure when placed against said opposing surface.

18. A contact device according to claim 17, wherein the enclosure comprises a gas inlet for maintaining a desired condition within the enclosure.

19. A support jig or clamp assembly comprising one or more pairs of contact devices according to claim 1, wherein a first contact device of said pair opposes a second contact device of said pair so as to enable a body to be held between said opposing first and second devices.
